(19) United States
(12) Patent Application Publication
(10) Pub. No.: US 2015/0226248 A1
(43) Pub. Date: Aug. 13, 2015

(54) Torque Tension Breakaway Nut

(71) Applicants: Roy Lee Robertson, JR., (US); Gregory Timmons, Delbarton, WV (US)

(72) Inventors: Roy Lee Robertson, JR., Delbarton, WV (US); Gregory Timmons, Holegate, OH (US); Dave Welch, Holegate, OH (US)

(21) Appl. No.: 14/621,687

(22) Filed: Feb. 13, 2015

Related U.S. Application Data
(60) Provisional application No. 61/939,648, filed on Feb. 13, 2014.

(51) Int. Cl. F16B 31/02; E21D 21/00; E21D 20/00; E21D 9/14; E21D 11/00

(52) U.S. Cl. CPC F16B 31/021; E21D 9/14; E21D 11/006; E21D 20/00; E21D 21/008

(57) ABSTRACT

The present invention regards a nut assembly including a novel breakaway nut, as part of a roof bolt assembly, for use in underground mines to support mine roofs. The present invention further regards a nut assembly for use in threaded bar installation in I-beam structure configurations in the construction industry. The nut assembly includes a breakaway nut affixed to a traditional nut used in roof bolt assemblies by means of a breakaway collar. Each of the breakaway nut, the collar and the traditional nut have an internal central aperture to receive a bolt, bar or cable. The breakaway nut has threading along the interior surface of its central aperture, wherein the diameter of at least the internal most portion of the threading is slightly smaller than the diameter of the threading of the bar or cable; the threading along the central aperture of the traditional nut is sized and configured to accommodate the threading of the bolt, bar or cable. The central aperture extending through the breakaway collar may have an internal diameter larger than the diameter of the threading of the bar or cable, and in some embodiments is threaded.

### BACKGROUND OF THE INVENTION

The present invention regards a nut assembly including a novel breakaway nut, as part of a roof bolt assembly, for use in underground mines to support mine roofs. The present invention further regards a nut assembly for use in threaded bar installation in I-beam structure configurations in the construction industry.

Roof bolt assemblies presently include bolts or cables, and nuts, wherein the bolts/cables have a threaded portion along the circumference of their shaft, and the nuts have a corresponding threaded interior aperture. The bolts/cables are installed into apertures in the roof, filled with glue or resin. Traditionally the bolt/cable and nut are torqued in a counter-clockwise direction to mix up the glue or resin. Then the bolt/cable is held in place to allow the glue to set. Finally the nut is torqued about the bolt/cable at higher foot-pounds and in a clockwise direction, causing compression of the roof thereby allowing the bolt system to carry the load of the roof and any movement thereof. During the counter-clockwise rotation of the bolt/cable and the nut, the rotation causes the nut to rock back and forth on the bolt/cable, causing significant damage to the edges of the corresponding threading on both the bolt/cable and the nut. Furthermore, when the nut is torqued clockwise onto the bolt/cable for roof compression, and such deterioration in the threading is present, the same generates a false torque reading on the roof bolter or other apparatus securing the bolt to the roof. The torque applied is directly proportional to the amount of tension in the bolt or cable. False torque readings result in over-tensioned and under-tensioned bolts, which provide insufficient support for the roof in the event the roof moves or deteriorates.

Similar issues of thread damage arise in the lateral installation of threaded bars on I-beams in the construction industry. These bars (threaded at both ends) are installed by passing the bar through an aperture of a first I-beam, through a wall or structure, and through a nut welded on a second I-beam, wherein the threaded end of the bar is rotated into the welded nut (having a corresponding threaded aperture to receive the threaded end of the bar) of the second I-beam. A loose nut is positioned on the other end of the threaded bar, outside of the first I-beam. The bar is rotated first into the welded nut of the second I-beam until the welded nut reaches an unthreaded portion of the bar; this rotation of the bar in its installation into the welded nut of the second I-beam causes the loose nut to rock back and forth on the bar, causing significant damage to the edges of the corresponding threading on both the bar and the loose nut.

The novel design of the present invention prevents rocking of the nut against the bolt/cable/bar during installation, and thereby prevents thread damage, in addition to other advantages over the prior art.

### GENERAL DESCRIPTION OF THE INVENTION

The present invention regards a nut assembly including a pair of nuts, and a collar affixing one nut to the other, useful in roof bolt assemblies and threaded bar installation in structural construction. Each of the nuts and the collar an internal central aperture to receive a bolt, bar or cable; the apertures within the nuts are threaded corresponding or in relation to the threading on the bolt, bar or cable with which it is intended for use. The collar is sized and configured to fail upon application of a certain torque (or range of torques) about the bolt, bar or cable, when the other end of the bolt, bar or cable is secured (e.g., set in the glue in an aperture of the roof; received in a secured nut of a structural I-beam).

The present invention further regards a roof bolt assembly, comprising a nut assembly and a threaded bolt or cable, useful in the underground mining industry to compress and strengthen an underground roof. Each of the nuts has a threaded internal central aperture to receive the bolt or cable. The collar has a central aperture, and is sized and configured to fail upon application of a certain torque (or range of torques) about the bolt/cable, when the other end of the bolt/cable is secured (e.g., set in the glue in an aperture of the roof; received in a secured nut of a structural I-beam).

The present invention further regards the installation of the afore-described roof bolt assembly in an under ground mine, and the use of the novel nut assembly of the present invention with threaded bars used in an I-beam configuration.

### DESCRIPTION OF THE DRAWINGS

FIG. 1 is a perspective view of an embodiment of the present invention.

FIG. 2 is a cut-away view of the embodiment shown in FIG. 1.

FIG. 3 is a side vide of an embodiment of the present invention.

FIG. 4 is a cut-away view of the embodiment shown in FIG. 3.

FIG. 5 is a side view of an embodiment of the present invention, installed on a roof bolt or cable.

FIG. 6 is a side view of the embodiment shown in FIG. 5, as the roof bolt/cable is being torqued into the roof to cause compression and support of the roof.

FIG. 7 is a side view of the installation of threaded bars through a structure, with parallel I-beams to support the bars, and embodiments of the present invention affixed to an end of each threaded bar.

### DETAILED DESCRIPTION OF THE INVENTION

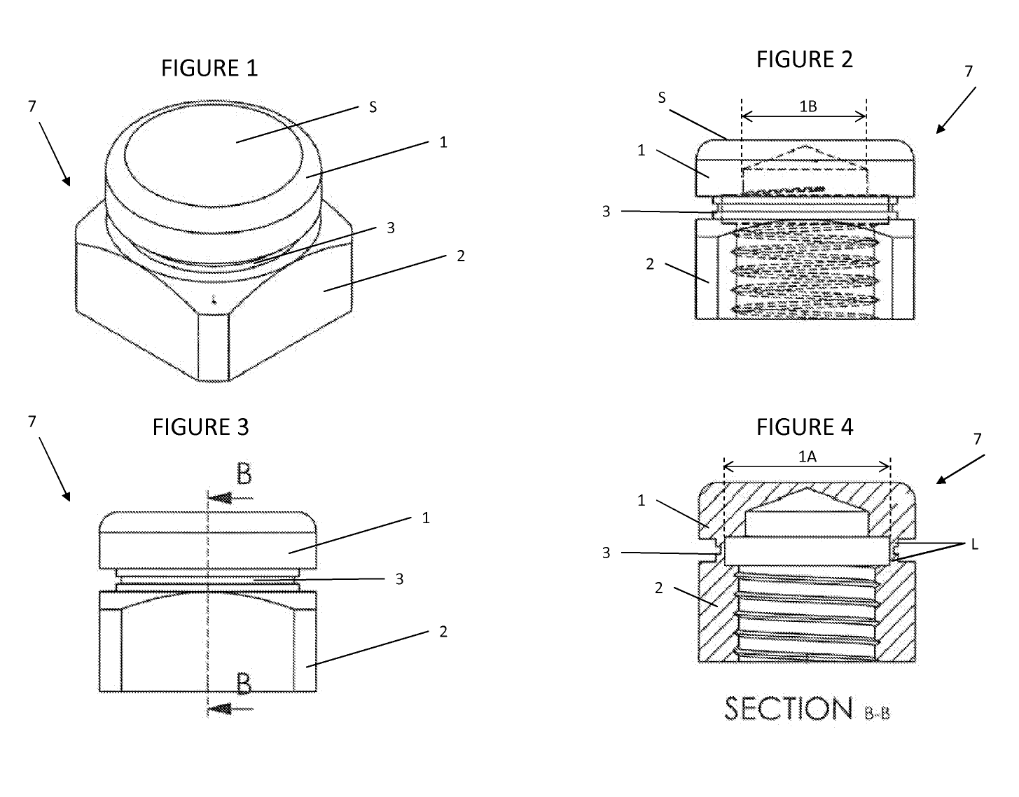

The nut assembly 7 of the present invention as depicted in FIGS. 1-4 includes a breakaway nut 1 affixed to a traditional nut 2 used in roof bolt assemblies by means of a breakaway collar 3. Each of the breakaway nut, the collar and the traditional nut have an internal central aperture to receive a bolt, bar or cable. This aperture may be ⅝″, ¾″, ⅞″, 1″, or larger or smaller. The breakaway nut 1 has threading along the interior surface of its central aperture, wherein the diameter 1B of at least the internal most portion of the threading is preferably slightly smaller than the diameter of the threading of the bar or cable; the threading along the central aperture of the traditional nut is sized and configured to accommodate the threading of the bolt, bar or cable. The central aperture extending through the breakaway collar has an internal diameter 1A larger than the diameter of the threading of the bar or cable, and in some embodiments is threaded.

The breakaway nut 1 may be made from 1215 metal, although other metals such as 12L14 metal are suitable for use in the present invention, and may be round, trapezoidal or any other shape. In some embodiments the breakaway nut has a closed surface S on the bottom thereof, such as a dome; in other embodiments the central aperture of the breakaway nut extends through the nut. In some embodiments the breakaway nut is a round nut, with rounded edges, serving to protect individuals from injury in the event that come in contact with the bottom of the bolt or cable. The breakaway nut may have a depth of between ⅛″ and ½″; in some embodiments the breakaway nut has a depth of ¼″, although other depths may be used.

When the breakaway nut 1 and the traditional nut 2, affixed together by means of the breakaway collar 3, are threaded onto the bolt B to make the roof bolt assembly 6, the internal threading of the breakaway nut inhibits further rotation of the traditional nut. The assembly may then be inserted into the aperture of the roof, spun clockwise by applying torque to the nut (e.g., 100-120 ft lbs) to mix the glue or resin, and held in place while the glue sets. This application of torque to the nut during mixing of the glue or resin may cause the threads of the cable or bolt to cut into the interior of the breakaway nut 1 and secure it to the end of the cable or bolt B. Although buttress and other thread styles for the bolt or cable may be used, standard thread style has a sharper edge and therefore is particularly suitable for securing the breakaway nut to the end of the bar or cable.

The breakaway collar 3 is sized and configured to fail upon application of a certain torque about the bolt, when the other end of the bolt is secured (e.g., set in the glue in an aperture of the roof). The breakaway collar is preferably made out of 1215 metal, although other materials such as 12L14 metal would be suitable for use in the invention. In some embodiments the breakaway collar has a diameter 1A less than the diameter of the breakaway nut and the traditional nut. The breakaway collar may have a height of between about 0.06″ to 0.2″; in some embodiments the breakaway collar has a height of about 0.12″, although these are provided as exemplary and not limiting features of the present invention. The breakaway collar may have a radial thickness of between about 0.1″ and 0.5″; in some embodiments the radial thickness of the breakaway collar 3 is about 0.125″. The radial thickness (as well as the height of the collar and the material used for the collar) contribute to the strength and intended failure of the collar, upon application of different torques. Your inventors have found that a breakaway collar having a radial thickness of about 0.125″ will fail when around 200 ft lbs of torque is applied to the traditional nut; increasing this radial thickness will increase the torque the collar can sustain before failing.

In some embodiments the breakaway nut and the traditional nut are secured to the breakaway collar by ledges L, above the top surface of the breakaway nut, and below the bottom surface of the traditional nut. The ledges L may be of uniform depth of between 0.02″ and 0.06″; in some embodiments the ledges L have a depth of about 0.04″.

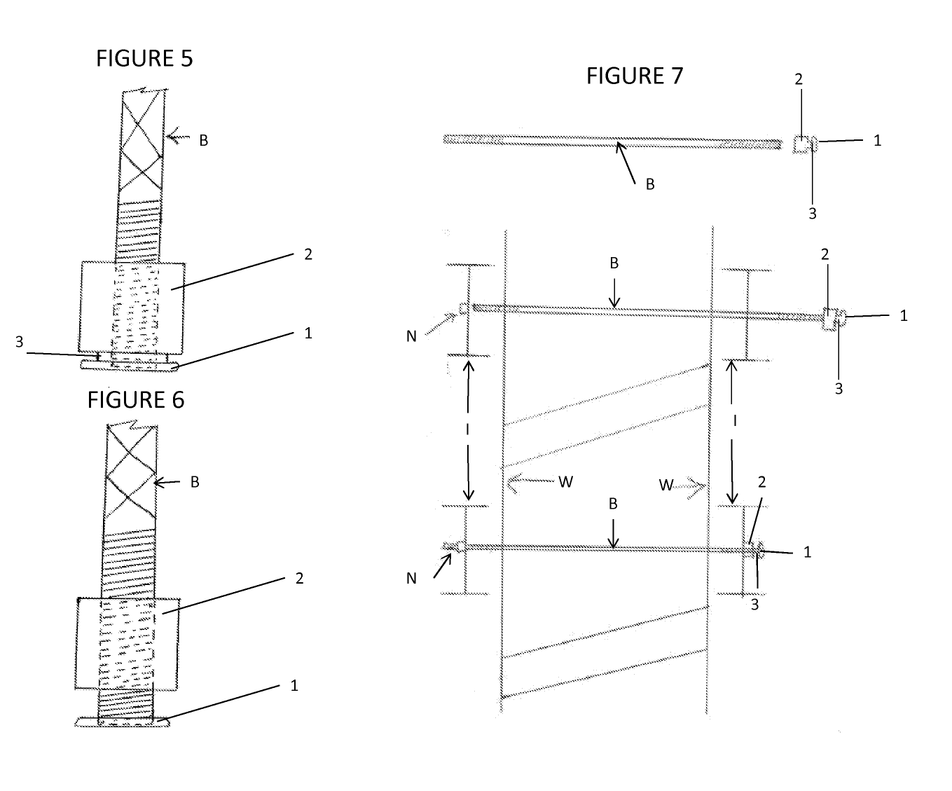

As depicted in FIGS. 5 and 6, the nut assembly 7 of the present invention is secured to a threaded end of a bolt, cable or bar B for use in roof bolt assemblies. With the nut assembly so secured, the bolt or cable B may be rotated at a first torque, until the second end thereof is set into the glue of an aperture in a mine roof, or is otherwise secured. Once the second end is secured and the breakaway nut 1 is secured to the end of the bolt/cable/bar preferably with the forced threading of the bolt/cable on the interior thereof, the traditional nut 2 may be further torqued about the threaded bolt/cable/bar at a higher torque (e.g., 170-200 ft. lbs), causing the breakaway collar to fail and upon further rotation of the traditional nut 2, the traditional nut 2 can move along the threaded bolt/cable, away from the breakaway nut 1, along the threading of the bolt/cable/bar. When installed into an aperture in a mine roof, tightening the bolt against the roof (or a plate against the roof) causes the area of the roof to be compressed and thereby strengthened.

As depicted in FIG. 7, the nut assembly of the present invention is secured to a threaded bar for use in lateral installation of the bar on I-beams in the construction industry. The bar (threaded at both ends) is installed by passing the bar through an aperture of a first I-beam I, through a wall or structure W, and through a nut N welded on a second I-beam, wherein the threaded end of the bar is rotated into the welded nut (having a corresponding threaded aperture to receive the threaded end of the bar) of the second I-beam. The nut assembly of the present invention is positioned on the other end of the threaded bar, outside of the first I-beam. The bar is rotated first into the welded nut of the second I-beam until the welded nut reaches an unthreaded portion of the bar (which will preclude further rotation of the bar). Thereafter, a greater torque is applied to the nut assembly of the present invention to cause the collar 3 to fail, and the traditional nut 2 may be further rotated about the bar until it is secure against the first I-beam; further rotation will cause a tight installation of the bar on the I-beams.

Because the present design inhibits rocking of the nut during mixing of the glue or insertion into the welded nut of an I-beam, thereby limiting thread damage and allowing true torque readings, the present invention overcomes the problems of the prior art and provides a reliable means for supporting a mine roof or steel structure. Other applications may be benefited by the use of the nut assembly of the present invention where tension is provided by a bolt, cable or bar, including affixation of multiple layers of metal.

1. A nut assembly for use with a threaded bolt comprising
a first nut,
a second nut, and
a breakaway collar, affixing said first nut to said second nut, wherein the breakaway collar is made of a thickness and material such that it will not fail upon application of a second torque to the first nut, whereby said second torque is less than such first torque, and that it will fail and release the first nut from the second nut upon application of a first torque to the first nut.

2. The nut assembly of claim 1, wherein the breakaway collar has a radial thickness of between about 0.1″ to 0.2″.

3. The nut assembly of claim 1, wherein the first nut is internally threaded, and the second nut is partially internally threaded.

4. The nut assembly of claim 3, wherein the second nut is made from a material capable of allowing a threaded bolt received in the threaded portion of the second nut to cut a groove to extend the threaded portion within the interior of the first nut when a torque less than the first torque is applied to the first nut.

5. The nut assembly of claim 3, wherein the collar has an internal radius slightly larger than the radius of the threaded bolt, and wherein at least a portion of the threaded aperture of the first nut has an internal radius slightly smaller than the radius of the threaded bolt.

6. The nut assembly of claim 1, wherein the second torque is at least 170 feet pounds, and the first torque is less than 170.

7. A method of installing a roof bolt in a mine roof comprising the steps of:
positioning a nut assembly as recited in claim 1 on a roof bolt;
inserting glue into an aperture in the mine roof, and placing the roof bolt into said aperture;
applying a first torque to the nut assembly;
allowing the bolt to set into the glue;
applying a second torque greater than the first torque to the nut so that the collar fails and the first nut is separated from the second nut;
rotating the second nut about the roof bolt until it pushes directly or indirectly into the roof and the bolt has tension sufficient to support the roof.

8. A method of installing a threaded bar on I-beam in a structure comprising the steps of
positioning a nut assembly as recited in claim 1 on a threaded bar;
inserting the threaded bar through an aperture on a first I-beam;
engaging the threaded bar through an aperture on a second I-beam and securing the same to a threaded nut affixed to said second I-beam;
applying a torque to the nut assembly so that the collar fails and the first nut is separated from the second nut;
rotating the second nut about the threaded bar until it pushes directly or indirectly on the I-beam and the bar has tension.
